(19) United States
(12) Patent Application Publication
(10) Pub. No.: US 2009/0295342 A1
(43) Pub. Date: Dec. 3, 2009

(54) Circuit and Method for Limiting a Current Flow in Case of a Shortage of a Support Capacitor

(76) Inventors: Martin Versen, Feldkirchen (DE); Achim Schramm, Munich (DE); Thomas v.d. Ropp, Grunertshofen (DE); Ankur Gupta, Neubiberg (DE)

Correspondence Address: SLATER & MATSIL, L.L.P., 17950 PRESTON ROAD, SUITE 1000, DALLAS, TX, 75252, US

(21) Appl. No.: 12/127,458

(22) Filed: May 27, 2008

(51) Int. Cl. G05F 3/16

(52) U.S. Cl. 323/225

(57) ABSTRACT

A circuit includes a voltage supply net, a first capacitor connected between the voltage supply net and a reference potential via a first transistor, and a second capacitor connected between the voltage supply net and the reference potential via a second transistor, such that the first and the second capacitor form at least a part of a support capacitance for the voltage supply net. The circuit is configured to provide control signals to control terminals of the first and second transistor such that the first transistor allows for a limited current flow in case of a shortage of the first capacitor and such that the second transistor allows for a limited current flow in case of a shortage of the second capacitor.

### TECHNICAL FIELD

Embodiments of the invention relate to circuits and methods for limiting a current flow in case of a shortage of a support capacitor of a supply voltage net.

### BACKGROUND

Almost every IC (integrated circuit) comprising voltage supply nets for providing, for example, (regulated) supply voltages also comprise support capacitors, which provide the supply voltages to internal or external electrical circuits. Support capacitors can equalize voltage drops or voltage ripples of the regulated supply voltages. An erroneous support capacitor, e.g., a shorted support capacitor, can lead to a supply voltage drop and hence to a malfunction of at least parts of the integrated circuit. Further, an erroneous support capacitor can lead to an increased current consumption and hence to an undesired warming of the integrated circuit.

Capacitor-based memories, such as, for example, DRAMs, are widely used in electronics industry for storing information as binary data. DRAMs are formed on integrated chips, diced from a semiconductor substrate and comprise (or consist of) an array of memory cells and peripheral circuits for randomly accessing the memory cells to store and retrieve information. Typically, individual memory cells are composed of a single field effect transistor (FET) and a charge storage capacitor or cell capacitor. The cell capacitor is often a trench capacitor formed in the semiconductor substrate or a stacked capacitor built over the memory cell.

A memory chip may sometimes also comprise a voltage regulator to provide a regulated voltage to the memory cells in the peripheral circuits. The regulated voltages may be provided to load circuits by means of a support capacitance for equalizing variations of the regulated voltage.

Support capacitors can be realized either planar or in the case of a DRAM-circuit (DRAM=dynamic random access memory) by modified memory cell fields, which comprise an array of memory cell capacitors. When using memory cell stacked capacitors with a capacitance of some fF (femto-Farad), and using an array of, e.g., 1,000 parallel memory cell capacitors for forming the support capacitance, this results in an overall support capacitance of some pF (pico-Farad).

In case of a DRAM circuit, a support capacitance can be realized by connecting a plurality of cell capacitors of a memory cell array (or a plurality of capacitors which have identical structure like capacitors of a memory cell array) in parallel to a voltage supply net. Assuming a single memory cell capacitor having a capacitance of 25 fF, an array of 25×40 memory cells could, for example, be used to realize on overall capacitance of about 25 pF. In case of a required support capacitance of some nF up to several hundreds of nF for an internal supply voltage, some 10 million memory cells may be required for this support capacitance.

Shortages of one or more individual capacitors in these dense support capacitance arrays may lead to a voltage drop of a supply voltage provided by the voltage supply net, to an increase of leakage currents, to an increase of load currents and to an increase of the probability that a power up of the integrated chip is not possible, in case more than one shortage is present. Assuming memory cell trench capacitors formed in the semiconductor substrate, a low-ohmic shortage (or low resistance shortage) in the range of a few Ohm is possible, leading to a current flow of several 100 mA, leading to a breakdown of the voltage supply net.

### SUMMARY OF THE INVENTION

Embodiments of the invention provide a circuit comprising a voltage supply net, a first capacitor connected between the voltage supply net and a reference potential via a first transistor and a second capacitor connected between the voltage supply net and the reference potential via a second transistor. The first and the second capacitor form at least part of a support capacitance for the voltage supply net. The circuit is configured to provide control signals to control terminals of the first and second transistor such that the first transistor allows for a limited current flow in case of a shortage of the first capacitor and such that the second transistor allows for a limited current flow in case of a shortage of the second capacitor.

Further embodiments of the invention provide a method for operating a circuit, for example, an integrated circuit, comprising a voltage supply net, and a first capacitor connected between the voltage supply net and a reference potential (for example, ground) via a first transistor, and a second capacitor connected between the voltage supply net and the reference potential via a second transistor, such that the first and the second capacitor form at least part of a support capacitance for the voltage supply net. The method comprises limiting a current by providing control signals to control terminals of the first and second transistor, such that the first transistor allows for a limited current flow in case of a shortage of the first capacitor and such that the second transistor allows for a limited current flow in case of a shortage of the second capacitor.

### BRIEF DESCRIPTION OF THE DRAWINGS

Embodiments of the invention will be explained in the following in further detail referring to the accompanying drawings, in which;

FIG. 1 shows a circuit diagram of a support capacitor circuit according to an embodiment of the invention;

FIG. 2 shows a circuit diagram of a support capacitor circuit according to a further embodiment of the invention;

FIG. 3 shows a memory cell capacitor array used as a support capacitance according to an embodiment of the invention;

FIG. 4 shows a memory cell capacitor array used as a support capacitance according to a further embodiment of the invention;

FIG. 5a shows a trench capacitor as a support capacitor according to an embodiment of the invention; and

FIG. 5b shows a stacked capacitor as a support capacitor according to an embodiment of the invention.

### DETAILED DESCRIPTION OF ILLUSTRATIVE EMBODIMENTS

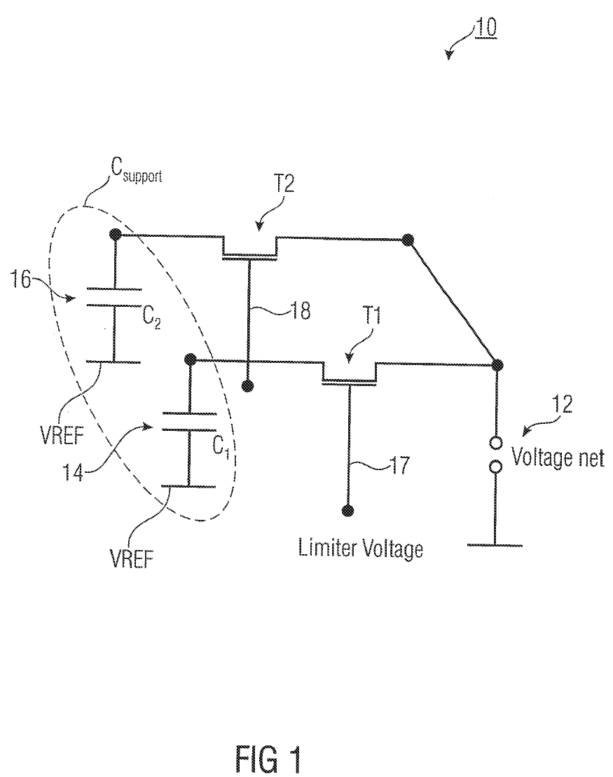

FIG. 1 shows a circuit 10 according to an embodiment of the invention.

The circuit 10 comprises a voltage supply net 12, which may comprise (or be coupled to), for example, a voltage regulator (not shown) for providing a regulated supply voltage. A first capacitor 14 having a capacitance C₁ is connected between the voltage supply net 12 and a reference potential (VREF) via a first transistor T1. A second capacitor 16 having a capacitance C₂ is connected between the voltage supply net 12 and the reference potential (VREF) via a second transistor T2, such that the first and the second capacitor 14, 16 form at least a part of a support capacitance Cₛᵤₚₚₒᵣₜ for the voltage supply net 12.

The circuit 10 is configured to provide control signals to control terminals 17, 18 of the first and second transistor T1, T2, such that the transistors allow for a limited current flow between the voltage supply net 12 and the reference potential (VREF) in case of a shortage of the first and/or second capacitor 14, 16.

The circuit 10 may provide control signals for the transistors T1, T2 to limit leakage currents through the first and second transistor T1, T2 in case of a shortage of at least one of the capacitors 14, 16, such that a drop of a supply voltage provided by the voltage supply net 12 caused by the shortage is limited to a predefined voltage drop value.

In this example, the support capacitance Cₛᵤₚₚₒᵣₜ for the voltage supply net 12 is determined by the two capacitors 14, 16 or their capacitances C₁, C₂ according to Cₛᵤₚₚₒᵣₜ=C₁+C₂. Of course, embodiments of the invention are not limited to the two capacitors 14, 16 shown in FIG. 1.

In circuits, especially in integrated DRAM circuits, the support capacitance Cₛᵤₚₚₒᵣₜ may be realized using an array of support capacitors 14, 16 comprising thousands or even millions of such support capacitors in the form of conventional DRAM memory cell capacitors. Hence, the circuit 10 may further comprise memory cells comprising cell capacitors, wherein the cell capacitors and the first and second capacitors 14, 16 are integrated on a common semiconductor substrate and wherein the cell capacitors and the first and second capacitor 14, 16 comprise identical layer sequences. In other words, in case the memory cells use trench capacitors as cell capacitors, the capacitors 14, 16 used for forming the support capacitance Cₛᵤₚₚₒᵣₜ may also be trench capacitors having capacitances in the order of the capacitances of the cell capacitors. The cell capacitors may be DRAM memory cell trench capacitors and a capacitance of the first and the second capacitors 14, 16 may range from 1/10-th of a capacitance of the DRAM memory cell capacitors to 10 times the capacitance of the DRAM memory cell trench capacitors. Likewise, if the cell capacitors are DRAM memory cell stacked capacitors, the capacitance of the first and second capacitors 14, 16 may range from 1/10-th of a capacitance of the DRAM memory cell stacked capacitors to 10 times the capacitance of the DRAM memory cell stacked capacitors. Since typical values for capacitances of cell capacitors lie in a range from 10 fF to 100 fF, the first and the second capacitor 14, 16 of the support capacitance Cₛᵤₚₚₒᵣₜ may, for example, comprise capacitances C₁, C₂ in the range of 3 fF to 300 fF or in the range from 10 fF to 100 fF.

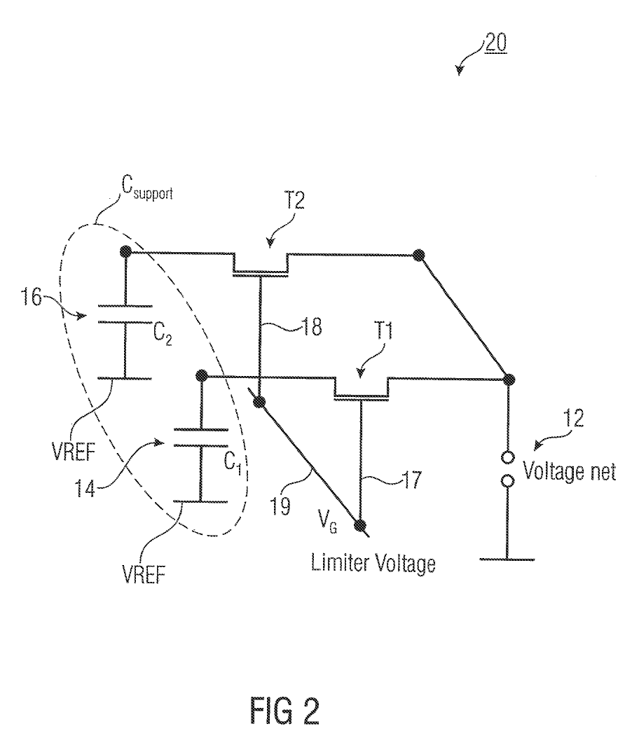

The control signals for the control terminals 17, 18 of the first and the second transistor T1, T2 may, for example, be provided such that the first and the second transistor T1, T2 have a resistance R in a range from 0.1 kΩ to 100 kΩ, respectively, in the presence of a shortage of the first or the second capacitor 14, 16. That is, in case of a shortage of one of the capacitors 14, 16 the associated transistor T1, T2 may not separate (or not completely separate) the shorted capacitor from the voltage supply net 12 but may, for example, allow a limited drain-source current I_{DS}. The control signals applied to the control terminals 17, 18 of the transistors T1, T2 allow for a gate-source voltage V_{GS} being greater than the threshold voltage V_{TH} of the transistors T1, T2. The control signals provided to the control terminals 17, 18 may be constant voltages, for example. In embodiments of the present invention the control signals provided to the control terminals 17, 18 may be identical control signals, as shown in FIG. 2.

In FIG. 2 control terminals 17, 18 are interconnected. A control signal V_{G} provided via interconnection 19 may, for example, be a constant control voltage. The common control signal V_{G} may be derived from the supply net 12, i.e., it may be identical to the supply voltage or it may be a voltage derived therefrom.

By realizing the support capacitance Cₛᵤₚₚₒᵣₜ using a plurality of individual support capacitors 14, 16, connected to the voltage supply net 12 via a plurality of transistors T1, T2, it can be achieved that the plurality of individual support capacitors is coupled to the voltage supply net 12 with a sufficiently low resistance due to the plurality of parallel current limiters in the form of a plurality of transistors T1, T2. At the same time, an undesired current-flow due to shortages in an area of the individual support capacitors 14, 16, only affecting specific support capacitance network segments, can be limited to sufficiently small values by means of the individual current limiters T1, T2.

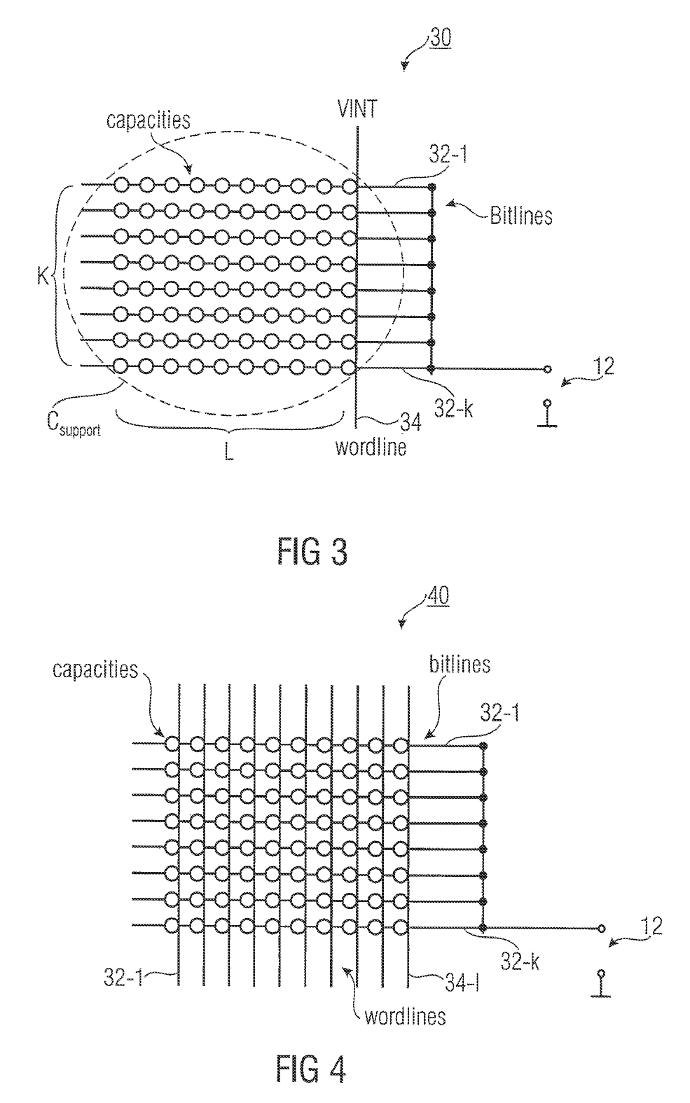

Referring now to FIG. 3, a support capacitance Cₛᵤₚₚₒᵣₜ of, for example, 500 pF is, for example, formed of (or using) a support capacitor array of 16×1024 individual 30 fF stacked capacitors. For example, L=16 individual capacitors are coupled to a line 32-k (k=1, . . . ,K; K=1024), which would serve as a bit line in case the support capacitor array 30 would be used as a conventional memory cell capacitor array. Here, however, the lines 32-k (k=1, . . . ,K; K=1024) are interconnected (or connected) to the voltage supply net 12. The K bit-line-like lines 32-k (k=1, . . . ,K; K=1024) may each comprise a transistor (e.g., a FET) as a current limiter. The current-limiter transistors may comprise the same structure as memory cell selection transistors of capacitance based memory cells. Selection transistors of memory cells and the current limiting transistors are integrated on a common semiconductor substrate and comprise identical layer sequences.

As can be seen, the lines 32-k (k=1, . . . ,K; K=1024) are shorted, such that voltage supply net 12 is connected to K=1024 support capacitors via lines 32-k (k=1, . . . ,K; K=1024) and the associated current limiting transistors (not shown), wherein each of the K=1024 support capacitors is formed by a parallel arrangement of L=16 cell capacitors, each having a cell capacitance of 30 nF. Hence, each of the K=1024 support capacitors has a capacitance of 16×30 fF=480fF. An individual support capacitor comprises a plurality of L capacitors (or cell capacitors) connected in parallel. For example, neighboring capacitors may comprise directly coupled electrodes, such that a capacitance of the individual support capacitor corresponds to the sum of L individual capacitances of the L capacitors (for cell capacitors) connected in parallel. The current limiting transistors may be NFETs having their control terminals connected to a supply voltage VINT provided by the supply voltage net 12, such that their ON-resistance R_{ON} is, for example, 5 kΩ. Thereby the control voltage VINT is provided via line 34, which would function as a word line in case the capacitor array would be used as a memory cell array.

In case of a presence of a shortage of one of the individual support capacitors, the resulting leakage current is limited via the respective current limiting transistor. In case the supply voltage has a value of, e.g., 1.3 V, a current due to a shortage can be limited to a value of about 200 μA (1.3 V/5 kΩ). The RC time constant τ for circuit 30 depicted in FIG. 3 has a value of τ=R_{ON}×480 fF=2.4 ns.

FIG. 4 shows a further embodiment of a circuit according to the invention.

While in FIG. 3, L individual parallel support capacitors (or cell capacitors) are connected to the voltage supply net 12 by (or via) a single current limiting transistor, FIG. 4 shows a circuit, wherein each of the plurality of L×K support capacitors is connected to the voltage supply net 12 via an associated current limiting transistor. The support capacitance Cₛᵤₚₚₒᵣₜ is, for example, realized by an array of 128×128 individual support capacitors, each having a support capacitance of, for example, 30 fF. That is, K=128 support capacitors are connected to each of the plurality of lines 32-k (k=1, . . . ,K; K=128), for example, via 128 individual transistors. The K=128 support capacitors of a bit-line-like lines 32-k are each connected to the support voltage net 12 via an associated current limiting transistor, which would be a memory cell selection transistor in case the support capacitor array would be used as memory cell array. The current limiting transistors connected between the support capacitors and the voltage supply net 12 may be NFETs with their control terminals connected to a control signal supply, such that their ON-resistance R_{ON} has a value of, for example, 30 kΩ. The current limiting transistors are all connected in parallel. Thereby the control voltage VINT is provided via L lines 34-l (l=1, . . . ,L) connected to the control signal supply, which lines 34-l would function as word lines in case the capacitor array would be used as a memory cell array.

In case of a presence of a shortage of one of the support capacitors, the associated current limiting transistor limits the resulting leakage current from voltage supply net 12 to reference potential VREF (e.g., ground). In case the supply voltage provided by supply voltage net 12 has a value of 1.3 V, a leakage current would be limited to about 40 μA (1.3 V/30 kΩ). The RC-time constant has a value of τ=30 kΩ×30 fF=0.9 ns in this case.

Hence, the access time for the support capacitance Cₛᵤₚₚₒᵣₜ can be kept sufficiently low in embodiments of the invention. A RC time constant, defined as a product of the ON-resistance of a current limiting transistor in the presence of a shortage of an individual support capacitor and a capacitance of the individual support capacitor, can be kept below 10 ns.

A method for providing a support capacitance Cₛᵤₚₚₒᵣₜ for a voltage supply net 12 comprises connecting a first capacitor 14 between the voltage supply net 12 and a reference potential VREF via a first transistor T1, connecting a second capacitor 16 between the voltage supply net 12 and the reference potential VREF via a second transistor T2, such that the first and the second capacitor 14, 16 form at least part of support capacitance Cₛᵤₚₚₒᵣₜ, and providing control signals to control terminals of the first and second transistors T1, T2 which are substantially independent from a presence of a shortage of the first or second capacitors 14, 16, to limit currents through the first and second transistors T1, T2, such that a drop of the supply voltage due to a shortage of the first or second capacitor 14, 16 is limited to a predetermined voltage drop value.

Providing control signals to the control terminals 17, 18 of the first and second transistors T1, T2 comprises coupling the control terminals 17, 18 to a common control signal supply 19, wherein a common control signal of the common control signal supply 19 may be derived from a supply voltage supplied by the voltage supply net 12.

Prior to connecting the first and the second capacitor 14, 16, the method may comprise integrating the first and second capacitors 14, 16 on a common semiconductor substrate, together with cell capacitors of memory cells such that the cell capacitors and the first and second capacitors 14, 16 comprise identical layer sequences. In other words, for building the first and second capacitors 14, 16, the same memory chip technology may be used as is used for building the cell capacitors. Due to this, the first and the second capacitors 14, 16 may each have substantially the same capacitance as a memory cell capacitor. That is, a capacitance of the first and second capacitors 14, 16 lies in a range from 1/10-th of a capacitance of a memory cell capacitor to 10 times the capacitance of a memory cell capacitor, depending on the geometry. The first and second capacitors 14, 16 might be integrated as trench capacitors formed in the semiconductor substrate or as stacked capacitors built over the cell.

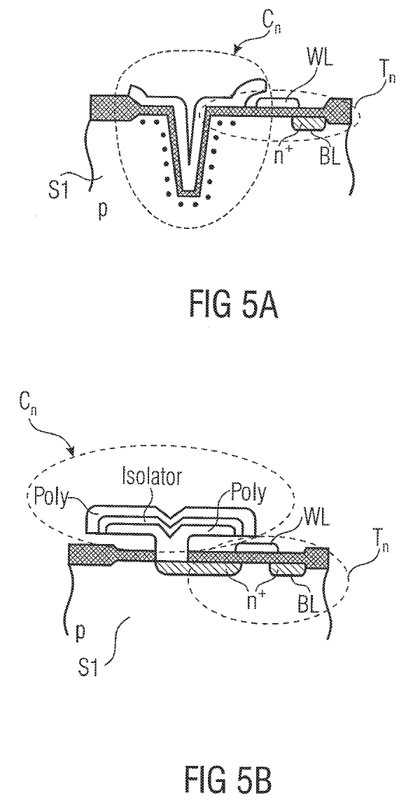

A layer structure or layer sequence of a support capacitor Cₙ in the form of a trench capacitor together with a current limiting transistor Tₙ is schematically depicted in FIG. 5A. The capacitor Cᵤ, in combination with the transistor Tₙ may, for example, take the place of C₁ and T₁, or of C₂ and T₂.

A n⁺-region BL denotes a contact region for coupling the transistor Tₙ to the supply voltage net 12 (not shown). The region WL (“wordline”) denotes the control terminal of the current limiting transistor Tₙ, which control terminal may be connected to a substantially constant control signal, which control signal may be derived from a regulated internal supply voltage VINT. The area denoted as Cₙ forms the trench capacitor of the individual support capacitor.

According to further embodiments, the individual support capacitors may as well be realized as stacked cell capacitors as schematically shown in FIG. 5b.

The stacked capacitor having a capacitance Cₙ is integrated on a p-doped semiconductor substrate 51, as shown in FIG. 5b. The capacitor Cₙ may be connected to the voltage supply net 12 via the transistor Tₙ. The control terminal WL of the transistor Tₙ may be connected to a substantially constant control signal, which may be derived from the regulated internal supply voltage VINT provided by voltage supply net 12. With region BL the support capacitor Cₙ may be connected, via transistor Tₙ, to voltage supply net 12. In other words, the region BL may be coupled, for example, without any intermediate switching elements to one of the bitlines 32-k. The region WL may, for example, form (or be coupled to) one of the wordlines 34-l to 34-L.

Embodiments of the invention hence may use a synergy between memory cell arrays and support capacitance cell arrays. Capacitors (or support capacitors) and transistors used in the support capacitance arrays may be principally the same (e.g., comprise technologically identical structures) as the cell capacitors and transistors used in the memory cell arrays. Therefore, a support capacitance and memory cells may be provided in a common technology and with common technology process steps. By coupling control terminals of current limiting transistors to a constant supply signal, e.g., to a voltage being greater than the threshold voltage V_{TH} of the current limiting transistors, and which might be derived directly or indirectly from the supply voltage net, the current limiting transistors can be used as resistances for limiting leakage currents in the presence of shortages of individual support capacitance cells.

In the following, the concept of reducing an impact of a shortage of one or more individual capacitors will be briefly summarized. For example, it is desirable to reduce a voltage drop caused by a shortage using this concept.

In general, current limiters may be used in order to reduce leakage currents and current consumption of an integrated circuit. Such a current limiter may act as an electric resistance between a support capacitance network and the voltage supply net.

Assuming a supply voltage of, e.g., 1.3 V, a resistance of, e.g., 1 kΩ or 30 kΩ would be sufficient to reduce a leakage current to about 1.3 mA or 40 μA.

However, such a resistive current limiter between the support capacitance structure and the voltage supply net could endanger a functionality of the support capacitance due to prohibitively high time constants, describing, for example, the time required to charge the support capacitance, through the resistance, to about 63% of its full charge, or to discharge it to about 37% of its initial voltage. Assuming a support capacitance of about Cₛᵤₚₚₒᵣₜ=500 pF (for example, comprising a 128×128 memory cell capacitor array with 30 fF per cell) and a resistance R=1 kΩ, a time constant τ=RCₛᵤₚₚₒᵣₜ=500 ns would result. Assuming a current limiter resistance R=30 kΩ for leakage current limiting results in a time constant τ=RCₛᵤₚₚₒᵣₜ=15 μs.

Embodiments of the invention realize a support capacitance Cₛᵤₚₚₒᵣₜ by arranging a plurality of individual support capacitors in parallel and by associating one current limiter to each of the plurality of the individual support capacitors. Since an individual support capacitor of the plurality of support capacitors comprises only a small capacitance being a fraction of the overall support capacitance, the resulting RC time constants remain small. Assuming an overall support capacitance Cₛᵤₚₚₒᵣₜ formed by N equal support capacitors circuited in parallel, the capacitance of an individual support capacitor has a value of about Cₙ=Cₛᵤₚₚₒᵣₜ/N (n=1, . . . ,N). By applying a current limiter to each of the plurality of support capacitors Cₙ, leakage currents can be successfully reduced and a support capacitance access time determined by the RC time constant can be reduced by a factor N to τ=RCₛᵤₚₚₒᵣₜ/N.

Embodiments of the invention can extend this concept, as described above, and as defined in the claims.

While this invention has been described in terms of several embodiments, there are alternations, permutations and equivalents which fall within the scope of this invention. It should also be noted that there are many alternative ways of implementing the methods and compositions of the present invention. It is therefore intended that the following independent claims be interpreted as including all such alternations, permutations and equivalents as fall within the true spirit and scope of the present invention.

What is claimed is:

1. A circuit, comprising:
a voltage supply net;
a first capacitor coupled between the voltage supply net and a reference potential via a first transistor; and
a second capacitor coupled between the voltage supply net and the reference potential via a second transistor, wherein the first and the second capacitor form at least a part of a support capacitance for the voltage supply net;
wherein the circuit is configured to provide control signals to control terminals of the first and second transistor such that the first transistor allows for a limited current flow in case of a shortage of the first capacitor and such that the second transistor allows for a limited current flow in case of a shortage of the second capacitor.

2. The circuit according to claim 1, wherein the circuit is configured to provide the control signals to limit a current through the first transistor in case of a shortage of the first capacitor and to limit a current through the second transistor in case of a shortage of the second capacitor, such that a drop of a supply voltage provided by the voltage supply net caused by the shortage is limited to a predetermined voltage drop value.

3. The circuit according to claim 1, wherein the control terminals of the first and second transistor are coupled to a common control signal supply.

4. The circuit according to claim 1, wherein the circuit further comprises memory cells comprising cell capacitors, wherein the cell capacitors and the first and second capacitor are integrated on a common semiconductor substrate and wherein the cell capacitors and the first and second capacitor comprise identical layer sequences.

5. The circuit according to claim 4, wherein the circuit is fabricated in a memory chip technology.

6. The circuit according to claim 4, wherein the cell capacitors are DRAM memory cell trench capacitors, and wherein capacitances of the first and the second capacitor range from 1/10-th of a capacitance of the DRAM memory cell trench capacitors to 10 times the capacitance of the DRAM memory cell trench capacitors.

7. The circuit according to claim 4, wherein the cell capacitors are DRAM memory cell stacked capacitors, and wherein capacitances of the first and the second capacitor range from 1/10-th of a capacitance of the DRAM memory cell stacked capacitors to 10 times the capacitance of the DRAM memory cell stacked capacitors.

8. The circuit according to claim 1, wherein the first and the second capacitor each have a capacitance in a range from 10 fF to 100 fF.

9. The circuit according to claim 1, wherein the circuit is configured to provide the control signals such that the first or the second transistor has a resistance in a range from about 0.1 kΩ to 100 kΩ in the presence of a shortage of the first or the second capacitor.

10. The circuit according to claim 9, wherein a first time constant is defined as a product of the resistance of the first transistor in the presence of a shortage of the first capacitor and a capacitance of the first capacitor and wherein a second time constant is defined as a product of the resistance of the second transistor in presence of a shortage of the second capacitor and a capacitance of the second capacitor and wherein the first and second time constants are below 10 ns.

11. The circuit according to claim 4, wherein the first or the second capacitor comprises a plurality of individual capacitors connected in parallel, such that a capacitance of the first or the second capacitor corresponds to a sum of individual capacitances of the parallel connected capacitors.

12. The circuit according to claim 2, wherein the circuit comprises a consumer circuit connected to the voltage supply net, and wherein the predetermined voltage drop value is in a tolerance range, such that a desired operation of the consumer circuit is not impaired by the shortage of the first or second capacitor.

13. The circuit according to claim 12, wherein the predefined voltage drop value is smaller than 5% of the supply voltage provided by the voltage supply net.

14. The circuit according to claim 1, wherein the circuit is configured to provide the control signals to the control terminals of the first and second transistor, such that the first transistor is operated as a current limiter in a turned-on mode of operation in the presence of a shortage of the first capacitor, or such that the second transistor is operated as a current limiter in a turned-on mode of operation in the presence of a shortage of the second capacitor.

15. The circuit according to claim 1, wherein the circuit is configured to provide the control signals such that the first transistor is operated in a turned-on mode of operation both in the presence and in the absence of a shortage of the first capacitor, and such that the second transistor is operated in a turned-on mode of operation both in the presence and in the absence of a shortage of the second capacitor.

16. An integrated memory circuit, comprising:
a plurality of memory cells, each memory cell comprising a corresponding cell capacitor;
a voltage supply net;
a first capacitor coupled between the voltage supply net and a reference potential via a first transistor; and
a second capacitor coupled between the voltage supply net and the reference potential via a second transistor, the first and the second capacitor forming at least a part of a support capacitance for the voltage supply net;
wherein control terminals of the first and second transistor are coupled to a common control signal supply to limit currents through the first and second transistor, such that a drop of a supply voltage caused by a shortage of the first capacitor is limited to a predetermined voltage drop value and such that a drop of the supply voltage caused by a shortage of the second capacitor is limited to a predetermined voltage drop value, and
wherein the cell capacitors and the first and second capacitor are integrated on a common semiconductor substrate and wherein the cell capacitors and the first and second capacitor comprise identical layer sequences.

17. The circuit according to claim 16, wherein each memory cell further comprises a selection transistor configured to selectively couple the corresponding cell capacitor to a bitline;
wherein the selection transistors and the first and second transistors are integrated on the common semiconductor substrate and wherein the first transistor, the second transistor and the cell transistors comprise identical layer sequences.

18. A circuit, comprising:
a plurality of capacitors, wherein each of the plurality of capacitors is coupled to a voltage supply net via an associated transistor;
wherein each of the associated transistors comprise a corresponding transistor control terminal; and
wherein the circuit is configured to bias the transistor control terminals, such that a given one of the associated transistors comprises a resistance in a range from 0.1 kΩ to 100 kΩ in the presence of a shortage of one of the capacitors coupled to the voltage supply net via the given transistor, in order to limit a current flow due to the shortage.

19. A method for operating a circuit comprising a voltage supply net, a first capacitor coupled between the voltage supply net and a reference potential via a first transistor and a second capacitor coupled between the voltage supply net and the reference potential via a second transistor, the first and the second capacitor forming at least a part of a support capacitance for the voltage supply net, the method comprising:
limiting a current by providing control signals to control terminals of the first and second transistor, such that the first transistor allows for a limited current flow in case of a shortage of the first capacitor and such that the second transistor allows for a limited current flow in case of a shortage of the second capacitor.

20. The method according to claim 19, wherein limiting the current comprises providing control signals to the first and second transistors, such that the first and the second transistors comprise a resistance in a range from 0.1 kΩ to 100 kΩ in the presence of a shortage of the first or the second capacitor.

21. The method according to claim 20, wherein limiting the current comprises providing control signals to the first and second transistor, such that a first time constant, defined as a product of the resistance of the first transistor in the presence of a shortage of the first capacitor and a capacitance of the first capacitor, and a second time constant, defined as a product of the resistance of the second transistor in the presence of a shortage of the second capacitor and a capacitance of the second capacitor, are below 10 ns.

22. The method according to claim 19, wherein limiting the current comprises coupling the control terminals of the first and second transistor to a common control signal derived from the voltage supply net.

23. The method according to claim 19, wherein limiting the current comprises providing control signals, such that a drop of a supply voltage provided by the voltage supply net caused by the shortage of the first or second capacitor is limited to a predetermined voltage drop value.

24. A method for providing a support capacitor for a voltage supply net, the method comprising:
coupling a first capacitor between the voltage supply net and a reference potential via a first transistor;
coupling a second capacitor between the voltage supply net and the reference potential via a second transistor, such that the first and the second capacitor form at least part of the support capacitor;
coupling control terminals of the first and second transistor to control signals that are substantially independent on a presence of a shortage of the first or second capacitor to limit currents through the first and second transistor, such that a drop of the supply voltage due to a shortage of the first capacitor is limited to a predetermined voltage drop value and such that a drop of the supply voltage due to a shortage of the second capacitor is limited to a predetermined voltage drop value.

25. The method according to claim 24, wherein, prior to coupling the first and second capacitor, the method further comprises integrating the first and second capacitor on a common semiconductor substrate together with cell capacitors of memory cells, such that the cell capacitors and the first and second capacitor comprise identical layer sequences.
